(19) United States
(12) Patent Application Publication
(10) Pub. No.: US 2005/0131663 A1
(43) Pub. Date: Jun. 16, 2005

(54) Simulating patient-specific outcomes

(75) Inventors: Alex L. Bangs, Foster City, CA (US); Kevin Lee Bowling, Watsonville, CA (US); Thomas S. Paterson, San Francisco, CA (US)

Correspondence Address: FISH & RICHARDSON P.C., PO BOX 1022, MINNEAPOLIS, MN, 55440-1022, US

(73) Assignee: Entelos, Inc., Foster City, CA (US)

(21) Appl. No.: 10/961,523

(22) Filed: Oct. 7, 2004

Related U.S. Application Data
(60) Provisional application No. 60/509,682, filed on Oct. 7, 2003.

(51) Int. Cl. G06G 7/48; G06G 7/58

(52) U.S. Cl. 703/11; 600/300

(57) ABSTRACT

The invention encompasses systems, methods, and apparatus for predicting and monitoring an individual's response to a therapeutic regimen. The invention includes multiple virtual patients, an associating subsystem operable to associate the subject with one or more of the virtual patients, and a simulation engine operable to apply one or more experimental protocols to the one or more virtual patients identified with the subject to generate a set of outputs. The set of outputs can represent therapeutic efficacy, identify biomarkers for monitoring therapeutic efficacy, or merely report the status of the biological system as it represents a particular individual

### A. RELATED APPLICATIONS

This application claims the benefit of U.S. Provisional Application No. 60/509,682, filed Oct. 7, 2003, which is herein incorporated by reference.

### I. INTRODUCTION

### B. FIELD OF THE INVENTION

This invention relates to the field of clinical decision support systems.

### C. BACKGROUND OF THE INVENTION

Developments in medicine and information technology are providing patients and physicians with a large and rapidly growing number of information sources relevant to health care. Every year adds new evidence relating to medical diagnosis and treatments are produced by researchers. In addition, access of professionals and patients to this valuable information is becoming increasingly easy. As a result, the amount of information well exceeds the ability of any individual to review, understand and apply this new information. A variety of clinical decision support systems (CDSS) have been developed to aid medical practitioners in seeking and filtering useful, valid information.

However, most clinical decision support systems are limited in their application to very specific tasks. Knowledge-based systems are the most common type of CDSS technology in routine clinical use. Although there are many variations, typically the knowledge within a CDSS is represented in the form of a set of rules. Common CDSS applications include (i) alerts and reminders (ii) diagnostic systems, typically in the form of a decision-tree, (iii) therapy critiquing that does not suggest a therapy, (iv) checking for drug-drug interactions, dosage errors, etc. in the prescription of medications; (v) information retrieval and (vi) image recognition and interpretation.

A more sophisticated clinical decision support system, called Archimedes, has been developed to simulate the complete healthcare environment, with every person, every doctor and every piece of equipment being represented and interacting as they do in reality. The Archimedes database contains vast amounts of data from numerous epidemiological and clinical trial studies. The data, in combination with the demographics of a virtual community health care system, and information about different treatments, progression of diabetes, medical personnel, facilities, and logistics of medical centers allow Archimedes users to evaluate multiple interventions, including; personal interventions like prevention, diagnosis, screening, treatment and support care, and organizational interventions such as quality improvement, care management, performance measurement, and changes in patient and practitioner behaviors. Eddy and Schlessinger, Diabetes Care 26:3093-3101 (2003) and Eddy and Schlessinger, Diabetes Care 26:3102-3110 (2003). While such a model can be very valuable for studying diseases, it provides no mechanism to evaluate interventions in a real individual. Indeed, no patient-specific clinical decision support system exists.

As a result, it would be desirable to have a system that is capable of assisting clinicians in the diagnosis and/or therapeutic intervention of patients, and that can take into account patient-specific data and information

### D. SUMMARY OF THE INVENTION

In one aspect, the invention provides systems comprising: (a) multiple virtual patients; (b) an associating subsystem operable to associate input data about a subject with one or more of the parameter sets to identify the subject with one or more of the virtual patients; (c) a simulation engine operable to apply one or more experimental protocols to the one or more virtual patients identified with the subject to generate a set of outputs, wherein the set of outputs projects an outcome for the subject relative to the one or more biological systems represented by the model. Each virtual patient comprises: (i) a model of one or more biological systems and (ii) a parameter set representing a single individual. In one embodiment, more than one virtual patient shares a common model. Preferably, the associating subsystem is operable to associate the input data with the one or more parameters sets under conditions where said input data and said one or more parameters sets are not completely matched. The model can be any model of a biological system, but preferably is a mechanistic model, physiologic model or disease model. Preferably, the model of a biological system is a model of a cardiovascular system, metabolism, bone, autoimmunity, oncology, respiratory, infection disease, central nervous system, skin, and/or toxicology. In a preferred embodiment, the model comprises a computer model representing a set of biological processes associated with the one or more biological systems, wherein each biological process is represented by a set of mathematical relations, wherein each mathematical relation comprises one or more variables representing a biological attribute or a stimuli that can be applied to the biological system. The input data about the subject can comprise a variety of information including observations by a medical practitioner, historical data about the subject, medications currently taken by the subject, diagnostic measurements, subject preferences and/or real-time measurements of physical characteristics of the subject. The output of the system can be any output relevant to predicting the status of the subject as it is represented by the modeled biological system. Preferred sets of output comprise a prognosis for the subject, a diagnosis for the subject, a prediction of the therapeutic efficacy of a proposed therapeutic regimen for the subject, and/or a recommendation of an appropriate therapeutic regimen for the subject. The therapeutic regiment can be proposed by a medical practitioner or by the system. The experimental protocol can be any manner of managing patient care. Exemplary, experimental protocols include alternative potential therapeutic regimens (i.e., surgical procedures, lifestyle changes or administration of one or more drugs) for the subject, or simple passage of time. The system, optionally can then recommend a set of diagnostic tests for the subject to take, the results of which can be received by the system and used to elucidate the association of the subject with one or more virtual patients.

In one embodiment of the invention, the associating subsystem comprises (i) one or more clusters of virtual patients, wherein each virtual patient in each cluster shares one or more common characteristics that taken together differentiate the virtual patients in the cluster from other virtual patients; and (ii) a correlator operable to associate a subject with a cluster of virtual patients when the input data correlates to the at least one common characteristic shared by the cluster of sets of physiological parameters. In an alternative embodiment of the invention, the associating subsystem comprises (i) one or more clusters of virtual patients, wherein each virtual patient in each cluster shares one or more common characteristics that taken together differentiate the virtual patients in the cluster from other virtual patients; (ii) a comparing subsystem operable to (1) compare the one or more common characteristics to the input data; (2) identify additional data necessary to identify the subject with one or more virtual patients; and (3) report the additional data to the user; and (iii) a correlator operable to associate a subject with a cluster of virtual patients when the input data correlates to the at least one common characteristic shared by the cluster of sets of physiological parameters. Preferably, the comparing subsystem further is operable to report to the user one or more diagnostic tests to obtain results relevant to the additional data necessary to identify the subject with one or more virtual patients. A cluster of virtual patients can consist of a single virtual patient or more than one virtual patients.

Another aspect of the invention provides computer-executable software code for simulating a biological system comprising: (a) code to define multiple virtual patients; (b) code to define an associating system operable to associate input data about a subject with one or more of the virtual patients to identify the subject with one or more associated virtual patients; and (c) code to define a simulation engine operable to apply one or more experimental protocols to each of the one or more associated virtual patients to generate a set of outputs, wherein the set of outputs projects an outcome for the subject relative to the one or more biological systems. In preferred embodiments, the model of one or more biological systems is a mechanistic model, physiologic model or disease model. Preferred sets of output comprise a prognosis for the subject, a diagnosis for the subject, a prediction of the therapeutic efficacy of a proposed therapeutic regimen for the subject, and/or a recommendation of an appropriate therapeutic regimen for the subject. In preferred embodiments, the computer-executable software code further comprises code to define an associating subsystem described above.

Yet another aspect of the invention provides methods of predicting a therapeutic efficacy for a subject comprising: (a) defining multiple virtual patients; (b) receiving user input data about a subject; (c) associating the input data with one or more of the virtual patients to identify the subject with one or more associated virtual patients; (e) defining one or more experimental protocols that represent potential therapeutic regimens for the subject; and (f) applying each of the one or more experimental protocols to the one or more associated virtual patients to generate a set of outputs, wherein the set of outputs projects the therapeutic efficacy of the therapeutic regimen for the subject. Preferably the therapeutic regimen is a lifestyle change, administration of a drug and/or effecting a surgical procedure. Preferably the model is a mechanistic model, a physiologic model, or a disease model. More preferably, the model comprises a computer model representing a set of biological processes associated with the one or more biological systems, wherein each biological process is represented by a set of mathematical relations, wherein each mathematical relation comprises one or more variables representing a biological attribute or a stimuli that can be applied to the biological system. In a preferred embodiment, associating the input data with one or more parameter sets comprises (i) grouping virtual patients, wherein each virtual patient in a group shares one or more common characteristics that taken together differentiate the virtual patients in the group from other virtual patients; (ii) comparing the one or more common characteristics to the input data; and (iii) associating the subject with a group of virtual patients when the input data correlates to the one or more common characteristics shared by the parameter sets in the group. In an alternative embodiment, associating the input data with one or more parameter sets comprises (i) grouping virtual patients, wherein each virtual patient in a group shares one or more common characteristics that taken together differentiate the virtual patients in the group from other virtual patients; (ii) comparing the one or more common characteristics to the input data; (iii) identifying additional data necessary to identify the subject with one or more virtual patients and reporting one or more tests to obtain the additional data; (iv) receiving results from the one or more tests to obtain the additional data; (iii) associating the subject with a group of virtual patients when the input data and additional data correlates to the one or more common characteristics shared by the virtual patients in the group. Optionally, steps (iii) and (iv) are repeated one or more times. A group of virtual patients can consist of a single virtual patient or can consist of more than one virtual patient. In one implementation, the method further comprises modifying a virtual patient to generate a new virtual patient that better represents the subject. In another embodiment, the method further comprises (g) receiving updated user input over time; (h) associating the updated input data with one or more of the parameter sets to identify one or more updated associated parameter sets; and (i) applying each of the one or more updated associated parameter sets to the model, to generate an updated set of outputs, wherein the updated set of outputs projects the therapeutic efficacy of the therapeutic regimen for the subject. In an alternative preferred embodiment, the method further comprises (g) grouping virtual patients that generate similar outcomes; (h) identifying one or more common characteristics that taken together differentiate the grouped virtual patients from all other virtual patients; and (i) reporting the identity of the one or more common characteristics to the user. Optionally, the method further comprises reporting to the user one or more diagnostic tests to obtain results relevant to the one or more common characteristics.

Yet another aspect of the invention provides methods of monitoring effectiveness of a therapeutic regimen in a subject comprising (a) defining multiple virtual patients; (b) receiving user input data about a subject; (c) associating the input data with one or more of the virtual patients to identify the subject with one or more associated virtual patients; (e) defining one or more experimental protocols that represent potential therapeutic regimens for the subject; (f) applying each of the one or more experimental protocols to the one or more associated virtual patients to generate a set of outputs; (g) performing a correlation analysis on the set of outputs to identify one or more biomarkers of therapeutic efficacy; and (h) monitoring the one or more biomarkers of therapeutic efficacy.

Another aspect of the invention provides apparatus and devices controlled by a system comprising: (a) multiple virtual patients; (b) an associating subsystem operable to associate input data about a subject with one or more of the parameter sets to identify the subject with one or more of the virtual patients; (c) a simulation engine operable to apply one or more experimental protocols to the one or more virtual patients identified with the subject to generate a set of outputs, wherein the set of outputs projects an outcome for the subject relative to the one or more biological systems represented by the model. Each virtual patient comprises: (i) a model of one or more biological systems and (ii) a parameter set representing a single individual. Preferably the apparatus or device is a closed-loop control system.

It will be appreciated by one of skill in the art that the embodiments summarized above may be used together in any suitable combination to generate additional embodiments not expressly recited above, and that such embodiments are considered to be part of the present invention

### II. BRIEF DESCRIPTION OF THE FIGURES

For a better understanding of the nature and objects of some embodiments of the invention, reference should be made to the following detailed description taken in conjunction with the accompanying drawings, in which:

FIG. 1 provides a block diagram of an exemplary embodiment of a clinical decision support system according to the invention.

FIG. 2 provides a block diagram of one example of simulation modeling software.

FIG. 3 shows a portion of a model designed to represent a biological system.

FIG. 4 shows an example of a process for creating virtual patients and analyzing the virtual patients to identify biomarkers.

FIG. 5 illustrates a flow chart to identify one or more biomarkers using an experimental protocol.

FIG. 6 shows a block diagram of a programmable processing system suitable for implementing or performing the apparatus or methods of the invention.

### III. DETAILED DESCRIPTION

A. Overview

The invention encompasses systems, methods, and apparatus for predicting and monitoring an individual's response to a therapeutic regimen. The invention includes multiple virtual patients, an associating subsystem operable to associate the subject with one or more of the virtual patients, and a simulation engine operable to apply one or more experimental protocols to the one or more virtual patients identified with the subject to generate a set of outputs. The set of outputs can represent therapeutic efficacy, identify biomarkers for monitoring therapeutic efficacy, or merely report the status of the biological system as it represents a particular individual.

B. Definitions

The term “mechanistic model,” as used herein, refers to a model comprising a set of differential equations used to describe the dynamic behavior of a process and its characteristics. Mechanistic models include causal models, . This goes beyond a causal model which typically links two or more causally-related variables in a mathematical relationship, but require the inclusion of at least but does not include one the underlying biological mechanism(s) connecting those variables.

The term “biologic mechanism”, as used herein, refers to an underlying mechanism which gives rise to a clinically-observable process. Biologic mechanisms may incorporate or be based on processes such as, e.g., the binding of a drug to a receptor (including, e.g., the binding constant); the catalysis of a particular chemical reaction, e.g., an enzymatic reaction (including, e.g., the rate of such a reaction); the synthesis or degradation of a cellular constituent, such as a molecule or molecular complex (including, e.g., the rate of such synthesis or degradation); the modification of a cellular constituent, such as the phosphorylation or glycosylation of a protein (including, e.g., the rate of such phosphorylation or glycosylation); and the like.

The term “physiologic model,” as used herein, refers to a mechanistic model that further includes one or more subclinical processes to represent the dynamics of healthy homeostasis and perturbations from homeostasis, i.e., to represent disease.

The term “subclinical process” refers to a process that is not easily measurable in a clinical setting, but that has downstream effects or consequences which typically can be measured in a clinical setting. Non-limiting examples of subclinical processes include the binding of a drug to a receptor (including, e.g., the binding constant); the catalysis of a particular chemical reaction, e.g., an enzymatic reaction (including, e.g., the rate of such a reaction); the synthesis or degradation of a cellular constituent, such as a molecule or molecular complex (including, e.g., the rate of such synthesis or degradation); the modification of a cellular constituent, such as the phosphorylation or glycosylation of a protein (including, e.g., the rate of such phosphorylation or glycosylation); and the like.

The term “disease model,” as used herein, refers to any model comprising a set of differential equations used to describe the dynamic behavior of a disease state.

As used herein, “lifestyle changes” refers to altering a subject's diet, activity level, exercise regimen, sleeping pattern, stress level and the like.

The term “experimental protocol,” as used herein refers to a modification applied to the model of one or more biological system to represent a real-life change in the environment and/or therapy of a subject. Exemplary experimental protocols include existing or hypothesized therapeutic agents and treatment regimens, mere passage of time, exposure to environmental toxins, increased exercise and the like.

As used herein, the term “subject” refers to a real individual, preferably to a human. Whereas, the term “virtual patient” refer to representations of the subject in the systems, apparatuses and methods of the present invention.

The verb “project” refers to the act of predicting a consequence. In the present case the consequence for a subject is inferred from the results of simulating an experimental protocol on one or more associated virtual patients.

The term “subject preference” refers to any choice that a subject may make that would positively or adversely. affect the results of a particular therapeutic regimen. Exemplary subject preferences include the subject's willingness or ability to change diet, to undergo surgery, to exercise, and/or to comply with a recommended treatment regimen.

The term “cellular constituent” refers to a biological cell or a portion thereof. Nonlimiting examples of cellular constituents include molecules such as DNA, RNA, proteins, glycoproteins, lipoproteins, sugars, fatty acids, enzymes; hormones, and chemically reactive molecules (e.g., H⁺; superoxides, ATP, and citric acid); macromolecules and molecular complexes; cells and portions of cells, such as subcellular organelles (e.g., mitochondria, nuclei, Golgi complexes, lysosomes, endoplasmic reticula, and ribosomes); and combinations thereof.

The term “biological constituent” refers to a portion of a biological system. A biological system can include, for example, an individual cell, a collection of cells such as a cell culture, an organ, a tissue, a multi-cellular organism such as an individual human patient, a subset of cells of a multi-cellular organism, or a population of multi-cellular organisms such as a group of human patients or the general human population as a whole. A biological system can also include, for example, a multi-tissue system such as the nervous system, immune system, or cardiovascular system. A biological constituent that is part of a biological system can include, for example, an extra-cellular constituent, a cellular constituent, an intra-cellular constituent, or a combination of them. Examples of biological constituents include DNA; RNA; proteins; enzymes; hormones; cells; organs; tissues; portions of cells, tissues, or organs; subcellular organelles such as mitochondria, nuclei, Golgi complexes, lysosomes, endoplasmic reticula, and ribosomes; chemically reactive molecules such as H⁺; superoxides; ATP; citric acid; protein albumin; and combinations of them.

The term “function” with reference to a biological constituent refers to an interaction of the biological constituent with one or more additional biological constituents. Each biological constituent of a biological system can interact according to some biological mechanism with one or more additional biological constituents of the biological system. A biological mechanism by which biological constituents interact with one another can be known or unknown. A biological mechanism can involve, for example, a biological system's synthetic, regulatory, homeostatic, or control networks. For example, an interaction of one biological constituent with another can include, for example, a synthetic transformation of one biological constituent into the other, a direct physical interaction of the biological constituents, an indirect interaction of the biological constituents mediated through intermediate biological events, or some other mechanism. In some instances, an interaction of one biological constituent with another can include, for example, a regulatory modulation of one biological constituent by another, such as an inhibition or stimulation of a production rate, a level, or an activity of one biological constituent by another.

The term “biological state” refers to a condition associated with a biological system. In some instances, a biological state refers to a condition associated with the occurrence of a set of biological processes of a biological system. Each biological process of a biological system can interact according to some biological mechanism with one or more additional biological processes of the biological system. As the biological processes change relative to each other, a biological state typically also changes. A biological state typically depends on various biological mechanisms by which biological processes interact with one another. A biological state can include, for example, a condition of a nutrient or hormone concentration in plasma, interstitial fluid, intracellular fluid, or cerebrospinal fluid. For example, biological states associated with hypoglycemia and hypoinsulinemia are characterized by conditions of low blood sugar and low blood insulin, respectively. These conditions can be imposed experimentally or can be inherently present in a particular biological system. As another example, a biological state of a neuron can include, for example, a condition in which the neuron is at rest, a condition in which the neuron is firing an action potential, a condition in which the neuron is releasing a neurotransmitter, or a combination of them. As a further example, biological states of a collection of plasma nutrients can include a condition in which a person awakens from an overnight fast, a condition just after a meal, and a condition between meals. As another example, biological state of a rheumatic joint can include significant cartilage degradation and hyperplasia of inflammatory cells.

A biological state can include a “disease state,” which refers to an abnormal or harmful condition associated with a biological system. A disease state is typically associated with an abnormal or harmful effect of a disease in a biological system. In some instances, a disease state refers to a condition associated with the occurrence of a set of biological processes of a biological system, where the set of biological processes play a role in an abnormal or harmful effect of a disease in the biological system. A disease state can be observed in, for example, a cell, an organ, a tissue, a multi-cellular organism, or a population of multi-cellular organisms. Examples of disease states include conditions associated with asthma, diabetes, obesity, and rheumatoid arthritis.

The term “biological process” refers to an interaction or a set of interactions between biological constituents of a biological system. In some instances, a biological process can refer to a set of biological constituents drawn from some aspect of a biological system together with a network of interactions between the biological constituents. Biological processes can include, for example, biochemical or molecular pathways. Biological processes can also include, for example, pathways that occur within or in contact with an environment of a cell, organ, tissue, or multi-cellular organism. Examples of biological processes include biochemical pathways in which molecules are broken down to provide cellular energy, biochemical pathways in which molecules are built up to provide cellular structure or energy stores, biochemical pathways in which proteins or nucleic acids are synthesized or activated, and biochemical pathways in which protein or nucleic acid precursors are synthesized. Biological constituents of such biochemical pathways include, for example, enzymes, synthetic intermediates, substrate precursors, and intermediate species.

Biological processes can also include, for example, signaling and control pathways. Biological constituents of such pathways include, for example, primary or intermediate signaling molecules as well as proteins participating in signaling or control cascades that usually characterize these pathways. For signaling pathways, binding of a signaling molecule to a receptor can directly influence the amount of intermediate signaling molecules and can indirectly influence the degree of phosphorylation (or other modification) of pathway proteins. Binding of signaling molecules can influence activities of cellular proteins by, for example, affecting the transcriptional behavior of a cell. These cellular proteins are often important effectors of cellular events initiated by a signal. Control pathways, such as those controlling the timing and occurrence of cell cycles, share some similarities with signaling pathways. Here, multiple and often ongoing cellular events are temporally coordinated, often with feedback control, to achieve an outcome, such as, for example, cell division with chromosome segregation. This temporal coordination is a consequence of the functioning of control pathways, which are often mediated by mutual influences of proteins on each other's degree of modification or activation (e.g., phosphorylation). Other control pathways can include pathways that can seek to maintain optimal levels of cellular metabolites in the face of a changing environment.

Biological processes can be hierarchical, non-hierarchical, or a combination of hierarchical and non-hierarchical. A hierarchical process is one in which biological constituents can be arranged into a hierarchy of levels, such that biological constituents belonging to a particular level can interact with biological constituents belonging to other levels. A hierarchical process generally originates from biological constituents belonging to the lowest levels. A non-hierarchical process is one in which a biological constituent in the process can interact with another biological constituent that is further upstream or downstream. A non-hierarchical process often has one or more feedback loops. A feedback loop in a biological process refers to a subset of biological constituents of the biological process, where each biological constituent of the feedback loop can interact with other biological constituents of the feedback loop.

The term “drug” refers to a compound of any degree of complexity that can affect a biological state, whether by known or unknown biological mechanisms, and whether or not used therapeutically. In some instances, a drug exerts its effects by interacting with a biological constituent, which can be referred to as a therapeutic target of the drug. A drug that stimulates a function of a therapeutic target can be referred to as an “activating drug” or an “agonist,” while a drug that inhibits a function of a therapeutic target can be referred to as an “inhibiting drug” or an “antagonist.” An effect of a drug can be a consequence of, for example, drug-mediated changes in the rate of transcription or degradation of one or more species of RNA, drug-mediated changes in the rate or extent of translational or post-translational processing of one or more polypeptides, drug-mediated changes in the rate or extent of degradation of one or more proteins, drug-mediated inhibition or stimulation of action or activity of one or more proteins, and so forth. Examples of drugs include typical small molecules of research or therapeutic interest; naturally-occurring factors such ;as endocrine, paracrine, or autocrine factors or factors interacting with cell receptors of any type; intracellular factors such as elements of intracellular signaling pathways; factors isolated from other natural sources; pesticides; herbicides; and insecticides. Drugs can also include, for example, agents used in gene therapy like DNA and RNA. Also, antibodies, viruses, bacteria, and bioactive agents produced by bacteria and viruses (e.g., toxins) can be considered as drugs. For certain applications, a drug can include a composition including a set of drugs or a composition including a set of drugs and a set of excipients.

C. Clinical Decision Support System

An aspect of the invention provides a model-based resource that can aid researchers and clinicians worldwide to improve human health. Applications of the invention can improve human health by serving as a knowledge base to serve education, research, and patient care communities to better understand human physiology and pathophysiology. The system can be used to evaluate the efficacy of drugs, nutriceuticals, diagnostics, medical devices, and combinations of the foregoing in the form of therapeutic packages targeted at reversing and curing a variety of diseases in individual patients. In addition, the invention can be used in developing defenses, for example, to understand individual patient response to environmental conditions including pesticides, pollution, and chemical or biological weapons.

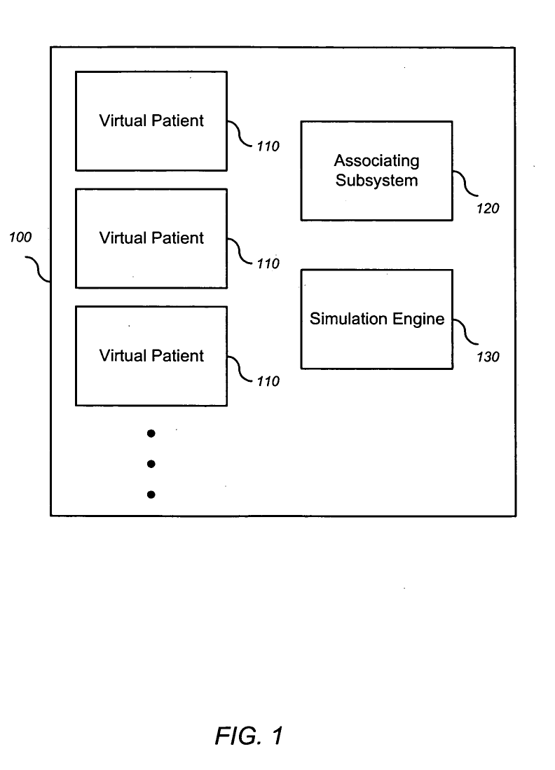

FIG. 1 illustrates one aspect of the invention, which provides a system 100 comprising: (a) multiple virtual patients 110; (b) an associating subsystem 120 operable to associate input data about a subject with one or more of the parameter sets to identify the subject with one or more of the virtual patients; (c) a simulation engine 130 operable to apply one or more experimental protocols to the one or more virtual patients identified with the subject to generate a set of outputs, wherein the set of outputs projects an outcome for the subject relative to the one or more biological systems represented by the model. Each virtual patient comprises: (i) a model of one or more biological systems and (ii) a parameter set representing a single individual.

The system of the invention can be preloaded with a number of virtual patients that represent an expected variance in a population. Variance in a population is typically of interest when such variance results in different responses to therapies, since a goal of the invention is to personalize recommendations of those therapies. Embodiments of the invention can provide selection of one or more virtual patients for a subject and also fine-tuning those virtual patients based on the subject's specifics. For example, if there are virtual patients at 90 kg and 100 kg, a virtual patient that is associated with a 95 kg subject can be created on-the-fly to allow for more accurate results. The newly created virtual patient can be automatically validated using the system.

In one implementation, the system can operate by associating real-life individuals, i.e., subjects, with virtual patients and then reporting what therapies work best when simulated for those virtual patients. The system can take inputs from a medical practitioner, such as a doctor or nurse, to first assess which diseases may be relevant for an individual. In some cases, the user input is sufficient to resolve the complexity of the virtual patient pool to identify one or more virtual patients that adequately represent the subject. If such is not the case, the doctor's inputs can be used to provide an initial narrowing of the characteristics of an appropriate virtual patient. For example, in obesity and diabetes, body weight can be a key input. Based on these inputs, the system can then determine which tests are needed to further categorize the subject. These tests can include, for example, a Hemoglobin A1c (“HbA1c”) measurement and a glucose tolerance test for a diabetic subject or a Forced Expiratory Volume in 1 Second (“FEV1”) test for an asthmatic subject. The tests to be run can be identified using a pre-completed decision tree or by running the simulation engine with a subset of the entire pool of virtual patients.

If preexisting virtual patients are used, recommended therapies can be pre-computed, thus, in effect, allowing a lookup of a table of results. Otherwise, individual therapies and combinations of therapies can be simulated to select a recommended therapy for a subject. In addition, biomarker analysis can be automatically performed on a newly created virtual patient, and biomarkers that are identified can be used to confirm the association of the virtual patient with a subject or to validate that a recommended therapy is working as expected.

Information received during a subject's visit (e.g., observations, measurements, drugs that a subject is taking, subject's preferences, physician's proposed treatment, and so forth) can be input into the clinical decision support system. The system, optionally can then recommend a set of diagnostic tests for the subject to take. Next, results of the set of tests can be input into the system.

In some instances, the system can also receive historical information about a subject, such as results of previous tests or observations from the same or a different medical practitioner. This information can be input via manual entry of patient history, extraction of information from an electronic medical record, or storage of information from previous uses of the system. This historical information can be used to further determine the condition of the subject. The historical information, further, can be used to monitor or validate previous association of the subject with one or more virtual patients. Subject preferences (e.g., whether the subject is willing or able to follow a particular regimen) can be another input to help determine a therapeutic approach.

Based on the results of the set of tests, the clinical decision support system can then provide to a doctor a diagnosis, a prognosis for the subject and the subject's projected response to a variety of treatment regimens and, optionally recommendations on an appropriate therapeutic approach for the subject, such as, for example, administration of one or more drugs as well as lifestyle change recommendations. The output of the system preferably would report a therapeutic efficacy for the therapeutic approach. Cost effectiveness can be addressed based on a combination of efficacy and costs. For example, the system of the invention can be used to predict efficacy and costs through a formulary supporting the subject's healthcare provider.

The clinical decision support system of the invention can allow a user to explore and experiment with a computer model of a disease. The user is able to understand what physiology is included in the computer model, what patient types are represented, and what therapies can be simulated. The user can try various therapies and lifestyle changes separately or in combination for different types of subjects to gain an understanding of how different subjects might respond.

The level of detail reported to a user can vary depending on the level of sophistication of the target user. For a healthcare setting, especially for use by members of the public, it may be desirable to include a higher level of abstraction on top of a computer model. This higher level of abstraction can show, for example, major physiological subsystems and their interconnections, but need not report certain detailed elements of the computer model—at least not without the user explicitly deciding to view the detailed elements. When representing a subject using a virtual patient, this higher level of abstraction can provide a description of the virtual patient's phenotype and underlying physiological characteristics, but need not include certain parametric settings used to create that virtual patient in the computer model. When representing a therapy, this higher level of abstraction can describe what the therapy does but need not include certain parametric settings used to simulate that therapy in the computer model. A subset of outputs of the computer model that is particularly relevant for subjects and doctors can be made readily accessible.

A higher level of abstraction can be implemented as a stand-alone system or as a layer on top of a more detailed model of a biological system, such as a PhysioLab® system. This higher level of abstraction can allow a user to perform more detailed analyses regarding the physiological or parametric details if desired. For example, research clinicians may appreciate the ability to explore the detailed elements of a computer model. Simulation outputs for various preset combinations of virtual patients and simulated therapies can be precomputed and can be readily presented to the user. Other combinations can be computed as needed and stored for future reference.

The system of the invention can be used by doctors to manage medical patients and to determine what therapies are appropriate for the medical patients. As the understanding of diseases improves and therapies get more specialized, a need exists to ensure that a subject's underlying physiology is better understood. Also, a need exists to ensure that available drugs are more specifically applied based on a better understanding of that subject. For example, the subject's preferences for a therapy (e.g., willingness or ability of the subject to change diet, to undergo surgery, to exercise, and/or to comply with a recommended treatment regimen) may affect whether a doctor should recommend the therapy.

The invention can be used to better manage subjects over time. A subject's medical record can be enhanced with an associated virtual patient to allow managing the subject over time. For example, if the subject visits a doctor, an analysis can be run using the virtual patient to obtain a diagnosis. Results from such analysis can be stored and re-computed over time as the subject revisits the doctor. The results can be used to validate and improve simulation predictions. If a discrepancy is observed, the results can be used to further study the subject to determine if there is a complication in the subject's condition or to determine if the subject should be associated with a different virtual patient or a different cluster of virtual patients. As the subject's condition improves or worsens over time, the subject can be associated with different virtual patients. This association over time can become part of the subject's medical record and can allow for a better understanding of disease progression in the subject. In addition, this association over time allows therapy recommendations to be adjusted as the subject's condition improves or worsens.

The invention also can be used to monitor subjects to look for changes in their condition, such as, for example, in critical care units. Also, this application can be used with devices and sensors that allow subjects to be monitored outside of a hospital or clinic. These devices and sensors can be used to record data for analysis, to provide input for a closed-loop control system (e.g., for an insulin pump), or to monitor the occurrence of adverse events. These devices and sensors can gather information automatically or can operate based on information that is input according to some protocol.

The system can allow additional capabilities in connection with subject monitoring. For example, when monitoring for adverse events, the system can provide information regarding adverse events and identification of biomarkers that are early indicators of those adverse events. Due to the ability to simulate a broad range of conditions and the ability to study the underlying physiology, the biomarkers can be more specific to the adverse events. Also, monitoring of adverse events can be customized to a specific subject through identification of a virtual patient or a cluster of virtual patients associated with the subject. Specific monitoring parameters appropriate for that virtual patient or cluster of virtual patients can be used for monitoring the subject.

Devices and sensors can also serve to identify a virtual patient that is associated with a specific subject. For example, a monitoring device can be used as part of a set of tests recommended by the system described above. Devices and sensors can also be used to validate a virtual patient association and a recommended therapy.

In addition, the invention can allow closed-loop control systems to be better designed based on the underlying physiology of subjects. Control parameters and monitoring parameters can be customized to specific subjects based on virtual patients that are associated with those subjects.

In addition, the system can be used to facilitate communication between a primary doctor and a specialist. In particular, this application can allow the primary doctor to communicate with the specialist and more experienced practitioners through the system of the invention. Communication between the doctor and the specialist can be in a clinical setting or in a telemedicine environment. For example, the doctor and the specialist can jointly use the system of the invention to determine how best to treat a subject. This collaboration can occur in a conference where they are accessing the system together. Also, this collaboration can occur through sharing information back and forth through the system or through other electronic communications (e.g., through links sent via email). The specialist can fine-tune a virtual patient association, either through manual interaction or through inputting further data that allows the system to perform association automatically. In each of these cases, having a subject's representation in the system and having the system accessible by healthcare professionals allow the subject to receive a more personalized treatment on an ongoing basis.

In addition to use in clinical and hospital settings, the present invention has applications in research and development; clinical data management; clinical trial design and management; target, diagnostic, and compound analysis; bioassay design; ADMET (absorption, distribution, metabolism, excretion, and toxicity) analysis; and biomarker identification.

For example, the invention can provide a database of virtual patients and their simulated responses to a variety of therapies. This database can allow researchers to perform more detailed analyses to understand how a specific real-life patient may respond to a specific therapy. For instance, this database can allow researchers to understand what happens along a particular pathway in the liver two hours after a therapy is applied. Virtual patients can represent hypotheses advocated in the scientific community that may not fully reproduce a phenotype of a particular disease. The system can allow a researcher to examine the underlying physiological representation of these hypotheses (without having to examine detailed parametric settings), and can highlight differences (if any) between the simulated phenotype and that seen clinically.

Healthcare institutions can have a large amount of clinical data available but may be unable to derive meaningful information from this clinical data. A computer model, such as that of the current invention, that links underlying physiology with clinical outcomes can improve understanding and use of this clinical data. Clinical data can be processed to associate subjects with virtual patients using a batch process. The association of subjects with virtual patients can provide data on the prevalence of different virtual patients. This information can be used with pharmaceutical R&D to assess the market potential of therapies that can be simulated for the virtual patients.

As a further example, the clinical data can be processed to associate subjects with virtual patients, and simulation results for the virtual patients can be interwoven with actual or clinical results for the subjects. For example, a subject may have a certain diagnostic test performed, but results of the test may provide limited information. Using the invention, the same test can be simulated for an associated virtual patient, and detailed simulation results (e.g., second by second) can be provided for more detailed analysis. Simulation results can be stored to provide a hybrid database of actual and simulated data that can allow for more sophisticated analyses, such as, for example, to search for biomarkers.

Various aspects of the invention can be automated. Alternatively, or in conjunction, a trained user can facilitate access to the system. It is contemplated that a medical practitioner can manually input processing options to associate a subject with a virtual patient or to confirm results of an automated association between the subject and the virtual patient. Similarly, a trained user can review results of the system to ensure that the results have been properly validated before presentation to a doctor and a subject.

D. Virtual Patients

The invention provides multiple virtual patients that can be associated to a subject. A virtual patient, as used herein, comprises a model of one or more biological systems and a parameter set representing a single individual. In the context of the complete system, multiple virtual patients can share a common model. As biological systems inherently are very complex, typically the model will be a computer model, however, the invention includes non-computer models of biological systems. Preferred biological systems for inclusion in a model include, but are not limited to, cardiovascular systems, metabolism, bone, autoimmunity, oncology, respiratory, infection disease, central nervous system, skin, and toxicology.

1. Modeling a Biological System

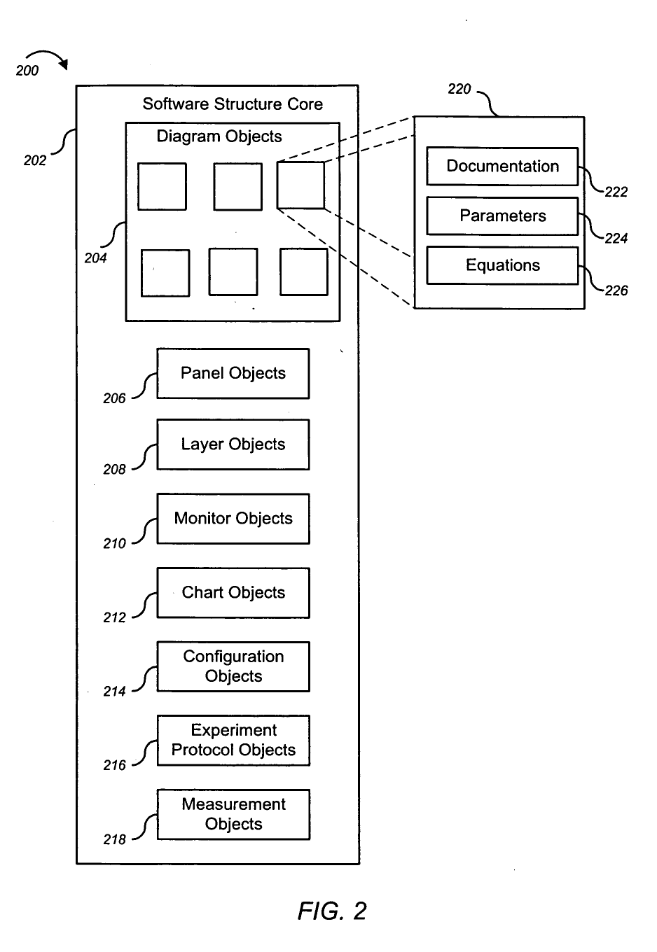

In one implementation, simulation modeling software is used to provide a computer model, e.g., as described in U.S. Pat. No. 5,657,255, issued Aug. 12, 1997, titled “Hierarchical Biological Modeling System and Method”; U.S. Pat. No. 5,808,918, issued Sep. 15, 1998, titled “Hierarchical Biological Modeling System and Method”; U.S. Pat. No. 6,051,029, issued Apr. 18, 2000, titled “Method of Generating a Display for a Dynamic Simulation Model Utilizing Node and Link Representations”; U.S. Pat. No. 6,539,347, issued Mar. 25, 2003, titled “Method of Generating a Display For a Dynamic Simulation Model Utilizing Node and Link Representations”; U.S. Pat. No. 6,078,739, issued Jan. 25, 2000, titled “A Method of Managing Objects and Parameter Values Associated With the Objects Within a Simulation Model”; and U.S. Pat. No. 6,069,629, issued May 30, 2000, titled “Method of Providing Access to Object Parameters Within a Simulation Model”. Referring to FIG. 2, there is provided a block diagram of one exemplary embodiment of simulation modeling software 200 useful for the present invention. An example of simulation modeling software is found in U.S. Pat. No. 6,078,739. Specifically, the modeling software 200 comprises a core 202, which may be coded using an object-oriented language such as the C++ or Java programming languages. Accordingly, the core 202 is shown to comprise classes of objects, namely diagram objects 204, access panel objects 206, layer panel objects 208, monitor panel objects 210, chart objects 212, configuration objects 214, experiment protocol objects 216, and measurement objects 218. As is well known within the art, each object within the core 202 may comprise a collection of parameters (also commonly referred to as instances, variables or fields) and a collection of methods that utilize the parameters of the relevant object.

An exploded view of the contents of an exemplary diagram object 220 is provided, from which it can be seen that the diagram object 220 includes documentation 222 that provides a description of the diagram object, a collection of parameters 224, and methods 226 which may define an equation or class or equations. The diagram objects 204 each define a feature or object of a modeled system that is displayed within a diagram window presented by a graphical user interface (GUI) that interacts with the core 202.

According to one implementation, the diagram objects 204 may include state, function, modifier and link objects, which are represented respectively by state nodes, function nodes, modifier icons and link icons within the diagram window. Each object defined within the software core 202 can have at least one parameter associated therewith which quantifies certain characteristics of the object, and which is used during simulation of the modeled system. It will also be appreciated that not all objects must include a parameter. In one implementation, several types of parameters are defined. Firstly, system parameters may be defined for each subject type. For example, a system parameter may be assigned an initial value for a state object, or a coefficient value for a link object. Other parameter types include object parameters and diagram parameters that facilitate easy manipulation of values in simulation operations.

The simulation modeling software described above may be used to generate a model for a complex system, such as one or more biological systems. In such a case, the simulation model may include hundreds or even thousands of objects, each of which may include a number of parameters. In order to perform effective “what-if” analyses using a simulation model, it is useful to access and observe the input values of certain key parameters prior to performance of a simulation operation, and also possibly to observe output values for these key parameters at the conclusion of such an operation. As many parameters are included in the expression of, and are affected by, a relationship between two objects, a modeler may also need to examine certain parameters at either end of such a relationship. For example, a modeler may wish to examine parameters that specify the effects a specific object has on a number of other objects, and also parameters that specify the effects of these other objects upon the specific object. Complex models are also often broken down into a system of sub-models, either using software features or merely by the modeler's convention. It is accordingly often useful for the modeler simultaneously to view selected parameters contained within a specific sub-model. The satisfaction of this need is complicated by the fact that the boundaries of a sub-model may not be mutually exclusive with respect to parameters, i.e., a single parameter may appear in many sub-models. Further, the boundaries of sub-models often change as the model evolves.

A computer model can be designed to model one or more biological processes or functions. The computer model can be built using a “top-down” approach that begins by defining a general set of behaviors indicative of a biological condition, e.g. a disease. The behaviors are then used as constraints on the system and a set of nested subsystems are developed to define the next level of underlying detail. For example, given a behavior such as cartilage degradation in rheumatoid arthritis, the specific mechanisms inducing the behavior are each be modeled in turn, yielding a set of subsystems, which can themselves be deconstructed and modeled in detail. The control and context of these subsystems is, therefore, already defined by the behaviors that characterize the dynamics of the system as a whole. The deconstruction process continues modeling more and more biology, from the top down, until there is enough detail to replicate a given biological behavior. Specifically, the model is capable of modeling biological processes that can be manipulated by a drug or other therapeutic agent.

In some instances, the computer model can define a mathematical model that represents a set of biological processes of a physiological system using a set of mathematical relations. For example, the computer model can represent a first biological process using a first mathematical relation and a second biological process using a second mathematical relation. A mathematical relation typically includes one or more variables, the behavior (e.g., time evolution) of which can be simulated by the computer model. More particularly, mathematical relations of the computer model can define interactions among variables, where the variables can represent levels or activities of various biological constituents of the physiological system as well as levels or activities of combinations or aggregate representations of the various biological constituents. A biological constituent that makes up a physiological system can include, for example, an extracellular constituent, a cellular constituent, an intracellular constituent, or a combination thereof. Examples of biological constituents include nucleic acids (e.g. DNA; RNA); proteins; enzymes; hormones; cells; organs; tissues; portions of cells, tissues, or organs; subcellular organelles such as mitochondria, nuclei, Golgi complexes, lysosomes, endoplasmic reticula, and ribosomes; chemically reactive molecules such as H+ superoxides, ATP, citric acid; and combinations thereof. In addition, variables can represent various stimuli that can be applied to the physiological system.

A computer model typically includes a set of parameters that affect the behavior of the variables included in the computer model. For example, the parameters represent initial values of variables, half-lives of variables, rate constants, conversion ratios, and exponents. These variables typically admit a range of values, due to variability in experimental systems. Specific values are chosen to give constituent and system behaviors consistent with known constraints. Thus, the behavior of a variable in the computer model changes over time. The computer model includes the set of parameters in the mathematical relations. In one implementation, the parameters are used to represent intrinsic characteristics (e.g., genetic factors) as well as external characteristics (e.g., environmental factors) for a biological system.

Mathematical relations used in a computer model can include, for example, ordinary differential equations, partial differential equations, stochastic differential equations, differential algebraic equations, difference equations, cellular automata, coupled maps, equations of networks of Boolean, fuzzy logical networks, or a combination of them.

Running the computer model produces a set of outputs for a biological system represented by the computer model. The set of outputs represent one or more biological states of the biological system, i.e., the simulated subject, and includes values or other indicia associated with variables and parameters at a particular time and for a particular execution scenario. For example, a biological state is represented by values at a particular time. The behavior of the variables is simulated by, for example, numerical or analytical integration of one or more mathematical relations produce values for the variables at various times and hence the evolution of the biological state over time.

In one implementation, the computer model can represent a normal state as well as a disease state of a biological system. For example, the computer model includes parameters that are altered to simulate a disease state or a progression towards the disease state. The parameter changes to represent a disease state are typically modifications of the underlying biological processes involved in a disease state, for example, to represent the genetic or environmental effects of the disease on the underlying physiology. By selecting and altering one or more parameters, a user modifies a normal state and induces a disease state of interest. In one implementation, selecting or altering one or more parameters is performed automatically.

The created computer model represents biological processes at multiple levels and then evaluates the effect of the biological processes on biological processes across all levels. Thus, the created computer model provides a multi-variable view of a biological system. The created computer model also provides cross-disciplinary observations through synthesis of information from two or more disciplines into a single computer model or through linking two computer models that represent different disciplines.

An exemplary, computer model reflects a particular biological system and anatomical factors relevant to issues to be explored by the computer model. The level of detail incorporated into the model is often dictated by a particular intended use of the computer model. For example, biological constituents being evaluated often operate at a subcellular level; therefore, the subcellular level can occupy the lowest level of detail represented in the model. The subcellular level includes, for example, biological constituents such as DNA, mRNA, proteins, chemically reactive molecules, and subcellular organelles. Similarly, the model can be evaluated at the multicellular level or even at the level of a whole organism. Because an individual biological system, i.e. a single human, is a common entity of interest with respect to the ultimate effect of the biological constituents, the individual biological system (e.g., represented in the form of clinical outcomes) is the highest level represented in the system. Disease processes and therapeutic interventions are introduced into the model through changes in parameters at lower levels, with clinical outcomes being changed as a result of those lower level changes, as opposed to representing disease effects by directly changing the clinical outcome variables.

In one implementation, the computer model is configured to allow visual representation of mathematical relations as well as interrelationships between variables, parameters, and biological processes. This visual representation includes multiple modules or finctional areas that, when grouped together, represent a large complex model of a biological system.

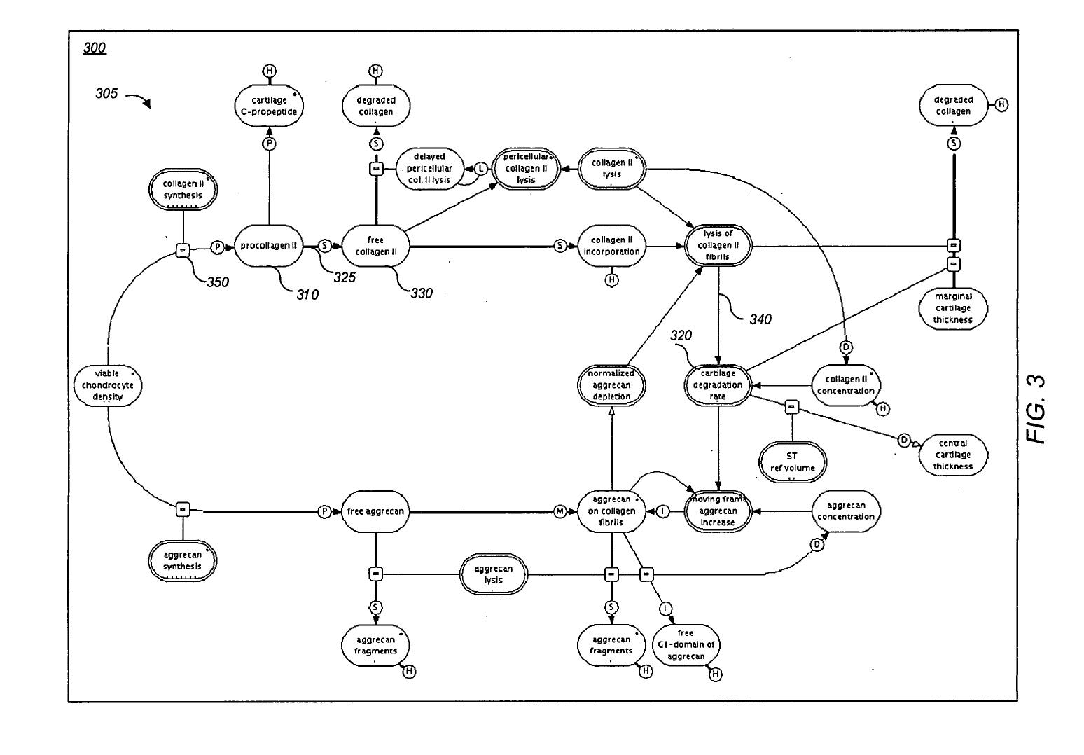

FIG. 3 shows a portion of a computer model designed to represent a biological system. Specifically, FIG. 3 illustrates a diagram of a portion 305 of a computer model 300. The portion 305 represents some of the biological processes for a joint. In particular, FIG. 3 shows cartilage matrix metabolism in the joint. Cartilage matrix metabolism affects different joint disease states including rheumatoid arthritis. The portion 305 includes biological processes related to cartilage degradation rate, which is a clinical outcome for rheumatoid arthritis.

The portion 305 shows a structural representation of the computer model including a number of different nodes. The nodes represent variables included in computer model 300. For example, the nodes represent parameters and mathematical relations included in computer model 300. Examples of the types of nodes are discussed below.

State nodes (e.g., state node 310), are represented in the computer model 300 as single-border ovals. The state nodes represent variables having values that can be determined by cumulative effects of inputs over time. In one implementation, values of state nodes are determined using differential equations. Parameters associated with each state node include an initial value (SO) and a status (e.g., value of the state node can be computed, held constant, or varied in accordance with specified criteria). A state node can be associated with a half-life and can be labeled with a half-life “H” symbol. An example of a state node is node 310, which represents procollagen.

Function nodes (e.g., function node 320), are represented in the computer model 300 as double-border ovals. The finction nodes represent variables having values that, at a particular point in time, are determined by inputs at that same point in time. Values of function nodes are determined using mathematical fuinctions of inputs. Parameters associated with a function node include an initial value and a status (e.g., value of the function node can be computed, held constant, or varied in accordance with specified output values corresponding to given inputs) as well as other parameters necessary to evaluate the finctions. An example of a function node is node 320, which represents the cartilage degradation rate.

The nodes are linked together within computer model 300 by links represented in FIG. 3 by lines and arrows. The links represent relationships between different nodes. Conversion links (e.g., arrow 325) are represented in computer model 300 as thick arrows. Conversion links represent a conversion of one or more variables represented by connected nodes. Each conversion link includes a label that indicates a type of conversion for the one or more variables. For example, a label of a conversion arrow with a “M” indicate a movement while a label of a “S” indicate a change of state of one or more variables. The computer model 300 also includes argument links 340. The argument links specify which nodes are inputs for the finction nodes (e.g., finction node 320).

A modeler can select from a set of link representations to represent a relationship condition that exists between two nodes within a computer model. Each of the link representations is associated with, and represents, a different relationship condition. A “constant effect” link representation indicates a relationship condition between first and second objects, for example, first and second state nodes, where the first object has an effect on the second object, and this effect is independent of any values of parameters associated with the first or second node. In one embodiment the link representation represents the effect as constant over the duration of a simulation operation. A “proportional effect” link representation represents a relationship condition between first and second objects wherein the first object has an effect on the second object, and the magnitude of this effect is dependent on the value of a parameter of the first object, represented by state node.

An “interaction effect” link representation represents that a first object, represented by a first state node, has an effect on a second object, represented by a second state node, and that the effect is dependent on the values of parameters of both the first and second objects.

A “constant conversion” link representation represents that instances of a first object represented by a state node are converted to instances of a second object represented by a second state node. The “constant conversion” link representation further represents that the number of instances converted is independent of any values of parameters associated with the first or second object. In one embodiment, the link representation denotes this conversion as being constant, and is not effected by external parameters.

A “proportional conversion” link representation represents that a number of instances of a first object, represented by a first state node, are converted to instances of a second object, represented by a second state node. Further, the link representation indicates that the number of instances converted is dependent on the number of instances of the first object.

An “interaction conversion” link representation represents that a number of instances of a first object, represented by a first state node, are converted to instances of a second object, represented by a second state node. Further, the “interaction conversion” link representation represents that the number of instances of the first object that are converted to instances of the second object is dependent upon respective numbers of instances of both the first and the second objects.

From the above description of the link representations, each link represents a relationship condition between first and second objects as being either an “effect” relationship or a “conversion” relationship. Further, each link representation represents the relationship condition as being either constant, proportional or interactive. The link representations and any appropriate link representations can be used to represent the various relationship conditions described above.

Referring back to FIG. 3, the computer model 300 also includes modifiers (e.g., modifier 350). Modifiers indicate the effects that particular nodes have on the arrows to which they are connected. Their effect is to allow time varying biological states to affect the rates of change of state nodes. The types of effects are qualitatively indicated by symbols in the boxes shown in FIG. 3. For example, a node can allow “A”, block “B”, regulate “=”, inhibit “−”, or stimulate “+” a relationship represented by a link.

The portion 305 of the computer model 300, therefore, illustrates the interactions between biological constituents associated with cartilage matrix metabolism. For example, node 310 represents procollagen. A conversion arrow 325 connects node 310 with node 330 representing free collagen. The conversion arrow 325 represents the conversion from procollagen to free collagen as part of the cartilage matrix metabolism process.

In one implementation, the computer model 300 includes one or more virtual patients. Various virtual patients of the computer model 300 are associated with different representations of a biological system. In particular, various virtual patients of the computer model 300 represent, for example, different variations of the biological system having different intrinsic characteristics, different external characteristics, or both. An observable condition (e.g., an outward manifestation) of a biological system is referred to as its phenotype, while underlying conditions of the biological system that give rise to the phenotype can be based on genetic factors, environmental factors, or both. Phenotypes of a biological system are defined with varying degrees of specificity. In some instances, a phenotype includes an outward manifestation associated with a disease state. A particular phenotype typically is reproduced by different underlying conditions (e.g., different combinations of genetic and environmental factors). For example, two human patients may appear to be similarly arthritic, but one can be arthritic because of genetic susceptibility, while the other can be arthritic because of diet and lifestyle choices. Exemplary models of biological systems include commercially available computer models: Entelos® Asthma PhysioLab® systems, Entelos® Metabolism PhysioLab® systems, and Entelos® Rheumatoid Arthritis PhysioLab® systems.

2. Generating Virtual Patients

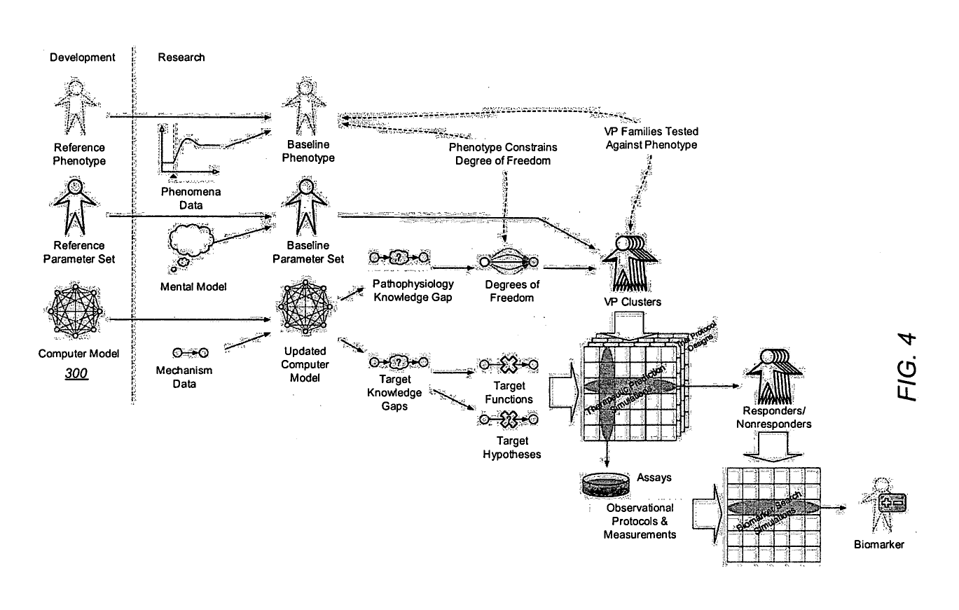

FIG. 4 shows an example of a process for creating virtual patients and analyzing the virtual patients to identify biomarkers. Example publications describing the generation or manipulation of virtual patients include U.S. Pat. No. 6,078,739; “Method and Apparatus for Conducting Linked Simulation Operations Utilizing A Computer-Based System Model”, (U.S. application Publication No. 20010032068, published on Oct. 18, 2001); and “Apparatus and Method for Validating a Computer Model”, (U.S. application Publication No. 20020193979, published on Dec. 19, 2002). Once various virtual patients are created, execution of a computer model can produce various sets of outputs, and correlation analysis can be performed on the sets of outputs to identify biomarkers. For example, correlation analysis can be performed on the sets of outputs to identify a set of outputs at an earlier point in time that can serve to predict or infer efficacy of a therapeutic regimen at a subsequent point in time.

For certain applications, various configurations of the computer model 300 can be referred to as virtual patients. A virtual patient can be defined to represent a human subject having a phenotype based on a particular combination of underlying conditions. Various virtual patients can be defined to represent human subjects having the same phenotype but based on different underlying conditions. Alternatively, or in conjunction, various virtual patients can be defined to represent human subjects having different phenotypes.

In some instances, a computer model can allow critical integrated evaluation of conflicting data and alternative hypotheses. The computer model can represent biological processes at a lower level and evaluate the impact of these biological processes on biological processes at a higher level. Thus, the computer model can provide a multi-variable view of a physiological system. The computer model can also provide cross-disciplinary observations through synthesis of information from two or more disciplines into a single computer model or through linking two computer models that represent different disciplines.

A virtual patient in the computer model 300 can be associated with a particular set of values for the parameters of the computer model 300. Thus, virtual patient A may include a first set of parameter values, and virtual patient B may include a second set of parameter values that differs in some fashion from the first set of parameter values. For instance, the second set of parameter values may include at least one parameter value differing from a corresponding parameter value included in the first set of parameter values. In a similar manner, virtual patient C may be associated with a third set of parameter values that differs in some fashion from the first and second set of parameter values.

One or more virtual patients in conjunction with the computer model 300 can be created based on an initial virtual patient that is associated with initial parameter values. A different virtual patient can be created based on the initial virtual patient by introducing a modification to the initial virtual patient. Such modification can include, for example, a parametric change (e.g., altering or specifying one or more initial parameter values), altering or specifying behavior of one or more variables, altering or specifying one or more functions representing interactions among variables, or a combination thereof. For instance, once the initial virtual patient is defined, other virtual patients may be created based on the initial virtual patient by starting with the initial parameter values and altering one or more of the initial parameter values. Alternative parameter values can be defined as, for example, disclosed in U.S. Pat. No. 6,078,739. These alternative parameter values can be grouped into different sets of parameter values that can be used to define different virtual patients of the computer model 300. For certain applications, the initial virtual patient itself can be created based on another virtual patient (e.g., a different initial virtual patient) in a manner as discussed above.

Alternatively, or in conjunction, one or more virtual patients in the computer model 300 can be created based on an initial virtual patient using linked simulation operations as, for example, disclosed in the following publication: “Method and Apparatus for Conducting Linked Simulation Operations Utilizing A Computer-Based System Model”, (U.S. application Publication No. 20010032068, published on Oct. 18, 2001). This publication discloses a method for performing additional simulation operations based on an initial simulation operation where, for example, a modification to the initial simulation operation at one or more times is introduced. In the present embodiment of the invention, such additional simulation operations can be used to create additional virtual patients in the computer model 300 based on an initial virtual patient that is created using the initial simulation operation. In particular, a virtual patient can be customized to represent a particular subject. If desired, one or more simulation operations may be performed for a time sufficient to create one or more “stable” virtual patient of the computer model 300. Typically, a “stable” virtual patient is characterized by one or more variables under or substantially approaching equilibrium or steady-state condition.

Various virtual patients of the computer model 300 can represent variations of the biological system that are sufficiently different to evaluate the effect of such variations on how the biological system responds to a given therapy. In particular, one or more biological processes represented by the computer model 300 can be identified as playing a role in modulating biological response to the therapy, and various virtual patients can be defined to represent different modifications of the one or more biological processes. The identification of the one or more biological processes can be based on, for example, experimental or clinical data, scientific literature, results of a computer model, or a combination of them. Once the one or more biological processes at issue have been identified, various virtual patients can be created by defining different modifications to one or more mathematical relations included in the computer model 300, which one or more mathematical relations represent the one or more biological processes. A modification to a mathematical relation can include, for example, a parametric change (e.g., altering or specifying one or more parameter values associated with the mathematical relation), altering or specifying behavior of one or more variables associated with the mathematical relation, altering or specifying one or more functions associated with the mathematical relation, or a combination of them. The computer model 300 may be run based on a particular modification for a time sufficient to create a “stable” configuration of the computer model 300.

A biological process that modulates biological response to the therapy can be associated with a knowledge gap or uncertainty, and various virtual patients of the computer model 300 can be defined to represent different plausible hypotheses or resolutions of the knowledge gap. By way of example, biological processes associated with airway smooth muscle (ASM) contraction can be identified as playing a role in modulating biological response to a therapy for asthma. While it may be understood that inflammatory mediators have an effect on ASM contraction, the relative effects of the different types of inflammatory mediators on ASM contraction as well as baseline concentrations of the different types of inflammatory mediators may not be well understood. For such a scenario, various virtual patients can be defined to represent human subjects having different baseline concentrations of inflammatory mediators

3. Validating Virtual Patients

One or more virtual patients in the computer model 300 can be validated with respect to the biological system represented by the computer model 300. Validation typically refers to a process of establishing a certain level of confidence that the computer model 300 will behave as expected when compared to actual, predicted, or. desired data for the biological system. For certain applications, various virtual patients of the computer model 300 can be validated with respect to one or more phenotypes of the biological system. For instance, virtual patient A can be validated with respect to a first phenotype of the biological system, and virtual patient B can be validated with respect to the first phenotype or a second phenotype of the biological system that differs in some fashion from the first phenotype.

One or more virtual patients in the computer model 300 can be validated using a set of virtual stimuli as, for example, disclosed in “Apparatus and Method for Validating a Computer Model”, U.S. application Ser. No. US 2002/0193979, published Dec. 19, 2002. A virtual stimulus can be associated with a stimulus or perturbation that can be applied to a biological system. Different virtual stimuli can be associated with stimuli that differ in some fashion from one another. Stimuli that can be applied to a biological system can include, for example, existing or hypothesized therapeutic agents, treatment regimens, and medical tests. Additional examples of stimuli include exposure to existing or hypothesized disease precursors. Further examples of stimuli include environmental changes such as those relating to changes in level of exposure to an environmental agent (e.g., an antigen), changes in feeding behavior, and changes in level of physical activity or exercise.

For certain applications, a virtual stimulus may be referred to as a stimulus-response test. By applying a set of stimulus-response tests to a virtual patient in the computer model 300, a set of results of the set of stimulus-response tests can be produced. The virtual patient can be validated if the set of results of the set of stimulus-response tests sufficiently conforms to a set of expected results of the set of stimulus-response tests. An expected result of a stimulus-response test can be based on actual, predicted, or desired behavior of a biological system when subjected to a stimulus associated with the stimulus-response test. When validating one or more virtual patients in the computer model 300 with respect to a phenotype of the biological system, an expected result of a stimulus-response test typically will be based on actual, predicted, or desired behavior for the phenotype of the biological system. The behavior of a biological system can be, for example, an aggregate behavior of the biological system or behavior of a portion of the biological system when subjected to a particular stimulus. By way of example, an expected result of a stimulus-response test can be based on experimental or clinical behavior of a biological system when subjected to a stimulus associated with the stimulus-response test. For certain applications, an expected result of a stimulus-response test can include an expected range of behavior associated with a biological system when subjected to a particular stimulus. Such range of behavior can arise, for example, as a result of variations of the biological system having different intrinsic properties, different external influences, or both.

A stimulus-response test can be created by defining a modification to one or more mathematical relations included in the computer model 300, which one or more mathematical relations can represent one or more biological processes affected by a stimulus associated with the stimulus-response test. A stimulus-response test can define a modification that is to be introduced statically, dynamically, or a combination of them, depending on the type of stimulus associated with the stimulus-response test. For example, a modification can be introduced statically by replacing one or more parameter values with one or more modified parameter values associated with a stimulus. Alternatively, or in conjunction, a modification can be introduced dynamically to simulate a stimulus that is applied in a time-varying manner (e.g., a stepwise manner or a periodic manner or toxin). For instance, a modification can be introduced dynamically by altering or specifying parameter values at certain times or for a certain time duration.

For certain applications, a stimulus-response test can be applied to one or more configurations of the computer model 300 using linked simulation operations as discussed previously. For instance, an initial simulation operation may be performed for a virtual patient, and, following introduction of a modification defined by a stimulus-response test, one or more additional simulation operations that are linked to the initial simulation operation may be performed for the virtual patient.

E. Associating Real Patients to Virtual Patients

To accomplish associating a subject with one or more virtual patients, at least one reference virtual patient is created. One or more clusters of virtual patients can be created from that reference virtual patient to represent “degrees of freedom” in the underlying physiology of that phenotype. The “degrees of freedom” can represent known or hypothesized variations in the underlying physiology that may be present in the phenotype. These hypothesized variations can be narrowed through filtering criteria to verify that the resulting virtual patients are realistic representations of real-life patients (e.g., meets certain physiological/clinical criteria). In some instances, each virtual patient has an associated prevalence (e.g., an indication of the number or proportion of real-life patients that is represented by the virtual patient). Alternatively, the prevalence of virtual patients can be managed by controlling the number of virtual patients with similar characteristics that are provided to the system. In some instances, a customized virtual patient can be created to represent a subject.

The system can comprise a correlator operable to group, or cluster, virtual patients that generate similar outcomes when simulating the source or similar experimental protocols. The correlator can also identify one or more common characteristics that, taken together, differentiate the grouped virtual patients from all other virtual patients. Additionally, the correlator, or the system, can report the identity of the common characteristic(s) to the user. Reporting the common characteristic(s) can include identifying a particular phenotype or identifying a diagnostic test, the result of which relates to the common characteristic(s).

The pool of virtual patients should cover the breadth of expected subjects that may appear including both basic clinical presentation as well as a range of underlying conditions, many of which will result in the same clinical presentation but would result in a different response to treatment regimens. For example, a pool of virtual patients, including a model of diabetes and/or obesity, would include virtual patients ranging from normal subjects through obese subjects, insulin insensitive subjects, mild to severe diabetic subjects. A subject may be obese, for example, because of genetic predispositions (e.g., Pima Indians) or because of lifestyle choices (e.g., high fat diet, no exercise). Accordingly, the pool of virtual patients should include virtual patients representing subjects with a predisposition to obesity and virtual patients representing subjects who are obese due to lifestyle choices.

Next, this pool of virtual patients is analyzed to identify biomarkers that differentiate them. The analysis can include simulating a set of known or hypothesized therapies for a disease of interest for the virtual patients. If specific patterns of response versus non-response are observed (e.g., a therapy works well for some virtual patients but not others), then the virtual patients can be further analyzed against one another to identify biomarkers that can be used to differentiate between subjects that are responders versus subjects that are non-responders. In addition, other biomarkers can be used to identify subjects as belonging to the phenotype. Even if responses to a therapy are predicted to be similar, biomarkers can be identified to differentiate between various virtual patients to provide for a better association between a subject and an individual virtual patient. The biomarkers for differentiating between various virtual patients can include common clinical measurements but may also include non-standard measurements to help differentiate clinically similar subjects, including, e.g., genetic or other detailed tests. If some subjects are in a particular state for historical reasons (e.g., diet), this may also be included as a differentiating factor. Typically, the analysis of a pool of virtual patients to identify differentiating biomarkers will be performed once, prior to distribution of the system to multiple users.

Next the subject will be associated with one or more virtual patients. A correlator. can associate a subject with a cluster of virtual patients that share one or more common characteristics when the input data about the subject correlates the one or more common characteristics. For example, the input data for each subject produce a vector of measurements describing this individual. This vector can then be compared to vectors of measurements for virtual patients to find one or more closest match. In an exemplary method, a likelihood assignment can be performed on the vectors. Each measurement may be given a different weighting if certain measurements are more important for finding a match. The likelihood of a virtual patient being representative of the subject would be based on the sum of weighted least squares between the virtual measurement vector and the actual measurement vector.

Separately from the assessment of a subject, the system, optionally, will establish the prevalence of each virtual patient in the virtual patient population to further assist the likelihood assignment process. Based on an evaluation of clinical population data, for example from clinical trials in the disease area of interest, the relative prevalence of each virtual patient could be established. This would be performed using some of the same methods for matching a subject to a virtual patient, but done with a whole population of subjects from the clinical trials, using detailed data collected during those trials.

In another embodiment, the system can include the additional dimension of time in the calculation. In other words, subjects will be matched to virtual patients not just by the single point measurements, but also match based on changes in those measurements over time. This change over time would typically be based on either response to initial courses of therapy, or the natural progression of the disease if it is being monitored but not yet treated in its early stages. For example, diabetic subjects typically get progressively worse in terms of their insensitivity to insulin. Updating the association of the subject to the pool of virtual patients could take into account these measures of disease progression. This is important in diseases where some subjects are progressing faster than others and would require a different, more aggressive treatment regime. The dimension of time may be incorporated in several ways. First, subject history or past subject measurements may be used at first presentation to the system to make some immediate calculations. Second, additional subject measurements may be planned to test for disease progression rates, i.e., take more measurements in a month. Third, a first estimate of a subject's match to a virtual patient may be made with updates to the match made as further data is available from future clinic visits.

If the result of a recommended therapy is substantially the same for the cluster of virtual patients, a specific assignment to an individual virtual patient is sometimes not required. Alternatively, the system of the invention, optionally, can recommend specific tests necessary to differentiate a subject's match to various virtual patients. The tests can be applied to a subject, and once results of the tests are returned, the system can report an association between the subject and a virtual patient with some degree of confidence.

In yet another embodiment of the invention, the system will suggest a set of tests that will not completely differentiate all possible virtual patients correlating to a subject. In some cases, the association of the subject to one or more appropriate virtual patients will occur through a multistep process. First, based on basic patient information gathered about the subject, the system will identify an initial set of tests to partially differentiate the proper virtual patients from the general pool of virtual patients. Based on the results from that first set of tests, further narrowing is achieved by a second (or additional) set of tests that apply only to certain subjects. This multistep process particularly, may be warranted if the later set of tests are expensive, invasive, time consuming, or otherwise undesirable for patients or physicians. Such a multistep process could ensure those tests were only taken where absolutely needed for properly assigning a subject.

In some instances, association of a subject with a virtual patient may not be a 100% certain process. The virtual patient can have some probability of being associated with the particular subject. This probability can be associated with a “knowledge gap” regarding certain diseases. The output of the system, optionally, can report the existence and/or degree of the knowledge gap. As the understanding of the diseases improves, a specific assignment to an individual virtual patient can be facilitated. In some instances, the subject can be associated with a cluster of virtual patients.

F. Utilization of Biomarkers by the Invention

As discussed above, the association of a subject with a virtual patient or a cluster of virtual patients can be facilitated by identification of biomarkers. For example, biomarkers can be identified to select or create tests that can be used to differentiate subjects. Also, biomarkers can be used to define and differentiate clusters of virtual patients in terms of predicted response or non-response to particular therapies. Biomarkers that differentiate responders versus non-responders may be sufficient if the specific goal is to identify a recommended therapy for a subject. In other cases, where associating a subject with an individual virtual patient is the goal, biomarkers can be identified to further define and differentiate between various virtual patients of a cluster of virtual patients. In addition, customized biomarkers can be identified to verify the association between the subject and the customized virtual patient. Further, biomarkers can be identified to monitor the actual response of a subject to a therapy.

More particularly, a biomarker can refer to a biological attribute that can be evaluated to infer or predict a particular. Biomarkers can be predictive of different effects. For instance, biomarkers can be predictive of effectiveness, biological activity, safety, or side effects of a therapy. According to one implementation, one or more biomarkers of a particular therapy can be identified using a computer model. The computer model can represent a biological system to which a therapy can be applied. The first step is to define an experimental protocol associated with the therapy. In one implementation, the experimental protocol can be defined to simulate the therapy. For certain applications, the experimental protocol can define a modification to the computer model to simulate the therapy.

The second step is to use the experimental protocol to identify one or more biomarkers. In one implementation, a set (i.e., one or more) of virtual measurements can be defined. Each virtual measurement of the set of virtual measurements can be associated with a different measurement for the biological system. The set of virtual measurements can include virtual measurements that are configured to evaluate the behavior of the computer model absent the experimental protocol as well as based on the experimental protocol. In the present embodiment of the invention, the computer model can be run to produce a set of results of the set of virtual measurements. Once produced, the set of results can be analyzed to identify one or more biomarkers of the therapy.

For certain applications, various configurations various virtual patients of the computer model 300 can represent variations of the biological system that are sufficiently different to evaluate the effect of such variations on how the biological system responds to a perturbation. In particular, one or more biological processes represented by the computer model 300 can be identified as playing a role in modulating biological response to a therapy, and various configurations can be defined to represent different modifications of the one or more biological processes.

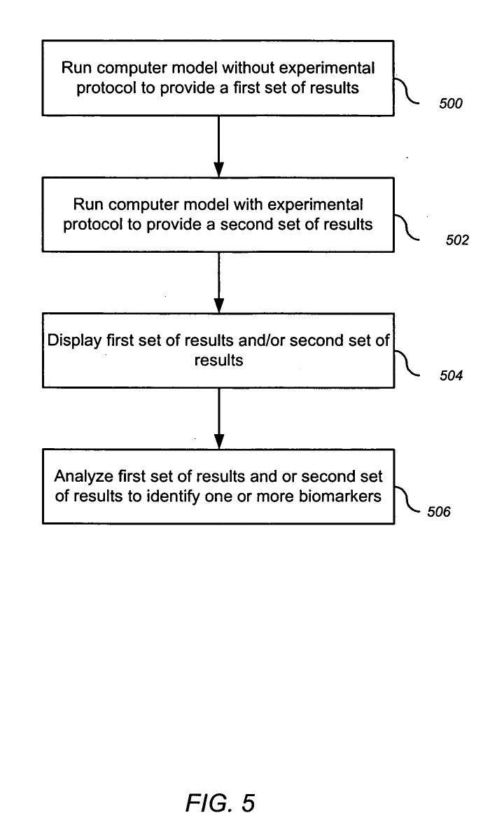

Biomarkers can be identified by applying an experimental protocol to a pool of virtual patients. Once an experimental protocol is defined for a therapy, it can be used for the purpose of identifying one or more biomarkers of the therapy using a model. FIG. 5 illustrates a flow chart to identify one or more biomarkers using an experimental protocol.

The first step shown in FIG. 5 is to execute a computer model absent the experimental protocol to produce a first set of results (step 500). A first set of virtual measurements can be defined to evaluate the behavior of one or more virtual patients in the computer model absent the experimental protocol. Accordingly, the first step (step 500) can entail applying the first set of virtual measurements to one or more virtual patients to produce the first set of results. Each virtual measurement of the first set of virtual measurements can be associated with a different measurement for a biological system absent the therapy, i.e., the experimental protocol.

In one implementation, the first set of virtual measurements is applied to multiple virtual patients in the computer model such that the first set of results can include results of the first set of virtual measurements for each virtual patient of the multiple virtual patients. The first set of virtual measurements may be applied to the multiple virtual patients simultaneously, sequentially, or a combination of them. For example, the first set of virtual measurements can be initially applied to a first virtual patient to produce results of the first set of virtual measurements for the first virtual patient. Subsequently, the first set of virtual measurements can be applied to a second virtual patient to produce results of the first set of virtual measurements for the second virtual patient. The first set of virtual measurements can be sequentially applied to the multiple virtual patients in accordance with an order that may be established by default or selected in accordance with a user-specified selection.

For certain applications, one or more results of the first set of results can be produced based on one or more virtual stimuli comprise in the experimental protocol. For example, the first step (step 500) can entail applying a virtual stimulus to one or more virtual patients of the computer model to produce the first set of results. The virtual stimulus can be associated with a stimulus that differs in some fashion from the actual therapy being simulated. In the present embodiment of the invention, various mathematical relations of the computer model, along with a modification defined by the virtual stimulus, can be solved numerically by a computer using standard algorithms to produce values of variables at one or more times based on the modification. Such values of the variables can, in turn, be used to produce the first set of results of the first set of virtual measurements.

With reference to FIG. 5, the second step shown is to run the computer model based on the experimental protocol to produce a second set of results (step 502). A second set of virtual measurements can be defined to evaluate the behavior of one or more virtual patients in the computer model based on the experimental protocol. Accordingly, the second step (step 502) can entail applying the second set of virtual measurements to one or more virtual patients to produce the second set of results. Each virtual measurement of the second set of virtual measurements can be associated with a different measurement for a biological system based on the therapy. The first and second set of virtual measurements can be associated with measurements configured to evaluate different biological attributes of a biological system. Alternatively, or in conjunction, the first and second set of virtual measurements can be associated with measurements configured to evaluate the same biological attributes of the biological system under different conditions.

For certain applications, the experimental protocol can be applied to multiple virtual patients of the computer model such that the second set of results can include results of the second set of virtual measurements for each virtual patient of the multiple virtual patients. The experimental protocol may be applied to the multiple virtual patients simultaneously, sequentially, or a combination of them. For instance, the experimental protocol can be sequentially applied to the multiple virtual patients in accordance with an order that may be established by default or selected in accordance with a user-specified selection.

Various mathematical relations of the computer model, along with a modification defined by the experimental protocol, can be solved numerically by a computer using standard algorithms to obtain values of variables at one or more times based on the modification. Such values of the variables can, in turn, be used to produce the second set of results of the second set of virtual measurements.

With reference to FIG. 5, the third step shown is to display one or both of the first set of results and the second set of results (step 504). A result can be displayed for each virtual measurement of the first and second set of virtual measurements. By displaying results for one or more virtual patients, the behavior of the one or more virtual patients can be evaluated to identify one or more biomarkers. For certain applications, reports, tables, or graphs can be provided to facilitate understanding by a user.

Referring back to FIG. 5, a fourth step shown is to analyze one or both of the first set of results and the second set of results to identify one or more biomarkers (step 506). For certain applications, identification of a biomarker can be made by a user evaluating the various results. Alternatively, or in conjunction, identification of a biomarker can be made automatically, and an indication can be provided to indicate whether the biomarker is identified.

The analysis implemented for the fourth step (step 506) can depend on the particular biomarker to be identified. For certain biomarkers, the fourth step (step 506) can entail comparing the first set of results with the second set of results. More particularly, the fourth step (step 506) can entail comparing results of the first set of virtual measurements for one or more virtual patients with results of the second set of virtual measurements for the one or more virtual patients. For instance, the first set of virtual measurements can include a first virtual measurement, and the second set of virtual measurements can include a second virtual measurement. The first virtual measurement can be associated with a first measurement configured to evaluate a first biological attribute of a biological system absent the therapy, and the second virtual measurement can be associated with a second measurement configured to evaluate a second biological attribute of the biological system based on a therapy. For example, the second biological attribute can be indicative of a particular effect of the therapy (e.g., effectiveness, biological activity, safety, or side effect of a therapy). Results of the first virtual measurement for multiple virtual patients can be compared with results of the second virtual measurement for the multiple virtual patients. More particularly, comparing the results of the first virtual. measurement for the multiple virtual patients with the results of the second virtual measurement for the multiple virtual patients can entail determining whether the results of the first virtual measurement are correlated with the results of the second virtual measurement. The first biological attribute can be identified as a biomarker that is predictive of the particular effect of the therapy based on determining that the results of the first virtual measurement are substantially correlated with the results of the second virtual measurement.

While a specific example of analyzing results of two virtual measurements (e.g., the first and second virtual measurements) is provided above, it should be recognized that, in general, results of two or more virtual measurements can be analyzed to identify a biomarker. For instance, the first set of virtual measurements can also include a third virtual measurement that is associated with a third measurement for the biological system, and the third measurement can be configured to evaluate a third biological attribute of the biological system absent the therapy. In the present example, results of the first and third virtual measurements for multiple virtual patients can be compared with results of the second virtual measurement for the multiple virtual patients. A combination of the results of the first and third virtual measurements can be determined to be substantially correlated with the results of the second virtual measurement, and a combination of the first and third biological attributes can be identified as a “multi-factorial” biomarker that is predictive of the particular effect of the therapy.

Results of two or more virtual measurements can be determined to be substantially correlated based on one or more standard statistical tests. Statistical tests that can be used to identify correlation can include, for example, linear regression analysis, nonlinear regression analysis, and rank correlation test. In accordance with a particular statistical test, a correlation coefficient can be determined, and correlation can be identified based on determining that the correlation coefficient falls within a particular range. Examples of correlation coefficients include goodness of fit statistical quantity, r², associated with linear regression analysis and Spearman Rank Correlation coefficient, rs, associated with rank correlation test.

Identified biomarkers can be verified using various methods. For certain applications, identification of a biomarker can be verified based on, for example, experimental or clinical data, scientific literature, results of a computer model, or a combination thereof. For instance, one or more additional virtual therapies can be defined to simulate different variations of the therapy (e.g., different dosages, treatment intervals, or treatment times), and the one or more additional virtual therapies can be processed as, for example, shown in FIG. 5 to verify identification of a biomarker with respect to the one or more additional virtual therapies. Alternatively, or in conjunction, one or more additional configurations can be defined, and identification of a biomarker can be verified by evaluating the behavior of the one or more additional configurations in a manner as described above.

G. Simulation Engine

Once various virtual patients of a computer model are defined, the behavior of the various virtual patients can be used for predictive analysis. In particular, one or more virtual patients can be used to predict behavior of a biological system when subjected to various stimuli.

An experimental protocol, e.g., a virtual therapy, representing an actual therapy can be applied to a virtual patient in an attempt to predict how a real-world equivalent of the virtual patient would respond to the therapy. Experimental protocols that can be applied to a biological system can include, for example, existing or hypothesized therapeutic agents and treatment regimens, mere passage of time, exposure to environmental toxins, increased exercise and the like. By applying an experimental protocol to a virtual patient, a set of results of the experimental protocol can be produced, which can be indicative of various effects of a therapy.

For certain applications, an experimental protocol can be created in a manner similar to that used to create a stimulus-response test, as described above. Thus, an experimental protocol can be created, for example, by defining a modification to one or mnore mathematical relations included in a model, which one or more mathematical relations can represent one or more biological processes affected by a condition or effect associated with the experimental protocol. An experimental protocol can define a modification that is to be introduced statically, dynamically, or a combination thereof, depending on the particular conditions and/or effects associated with the experimental protocol.

In the present embodiment of the invention, a set of virtual measurements can be defined such that a set of results of an experimental protocol can be produced for a particular virtual patient. Multiple virtual measurements can be defined, and a result can be produced for each of the virtual measurements. A virtual measurement can be associated with a measurement for a biological system, and different virtual measurements can be associated with measurements that differ in some fashion from one another.

For certain applications, a set of virtual measurements can include a first set of virtual measurements and a second set of virtual measurements. The first set of virtual measurements can be defined to evaluate the behavior of one or more virtual patients absent the experimental protocol, while the second set of virtual measurements can be defined to evaluate the behavior of the one or more virtual patients based on the experimental protocol. The first and second set of virtual measurements can be associated with measurements configured to evaluate different biological attributes of a biological system. Alternatively, or in conjunction, the first and second set of virtual measurements can be associated with measurements configured to evaluate the same biological attributes of the biological system under different conditions. For instance, the first set of virtual measurements can include a first virtual measurement that is associated with a first measurement, and the second set of virtual measurements can include a second virtual measurement that is associated with a second measurement. In this example, the first measurement can be configured to evaluate a first biological attribute of the biological system absent the therapy, and the second measurement can be configured to evaluate the first biological attribute or a second biological attribute based on the therapy.

This invention can include a single computer model that serves a number of purposes. Alternatively, this layer can include a set of large-scale computer models covering a broad range of physiological systems. Examples of large-scale computer models are listed below. In addition, the system can include complementary computer models, such as, for example, epidemiological computer models and pathogen computer models. For use in healthcare, computer models can be designed to analyze a large number of subjects and therapies. In some instances, the computer models can be used to create a large number of validated virtual patients and to simulate their responses to a large number of therapies.

Underlying the large-scale computer models can be computer models of key physiological systems that may be shared across the large-scale computer models. Examples of such physiological systems include the immune system and the inflammatory system, as described, e.g., in the following published US patent applications: U.S. Ser. No. 2003/0058245 A1, published Mar. 27, 2003, titled “Method and Apparatus for Computer Modeling Diabetes”; U.S. Ser. No. 2003/0078759, published Apr. 24, 2003, titled “Method and Apparatus for Computer Modeling a Joint”; and U.S. Ser. No. 2003/0104475, published Jun. 5, 2003, titled “Method and Apparatus for Computer Modeling of an Adaptive Immune Response”. These underlying computer models may also be directly accessed for cross-disease research.

A computer model can be run to produce a set of outputs or results for a physiological system represented by the computer model. The set of outputs can represent a biological state of the physiological system, and can include values or other indicia associated with variables and parameters at a particular time and for a particular execution scenario. For example, a biological state can be mathematically represented by values at a particular time. The behavior of variables can be simulated by, for example, numerical or analytical integration of one or more mathematical relations. For example, numerical integration of the ordinary differential equations defined above can be performed to obtain values for the variables at various times and hence the evolution of the biological state over time.

A computer model can represent a normal state as well as an abnormal state (e.g., a disease or toxic state) of a physiological system. For example, the computer model can include parameters that can be altered to simulate an abnormal state or a progression towards the abnormal state. By selecting and altering one or more parameters, a user can modify a normal state and induce an abnormal state of interest. By selecting and altering one or more parameters, a user can also represent variations of the physiological system in connection with creating various virtual patients. In some embodiments of the invention, selecting or altering one or more parameters can be performed automatically.

The invention and all of the finctional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

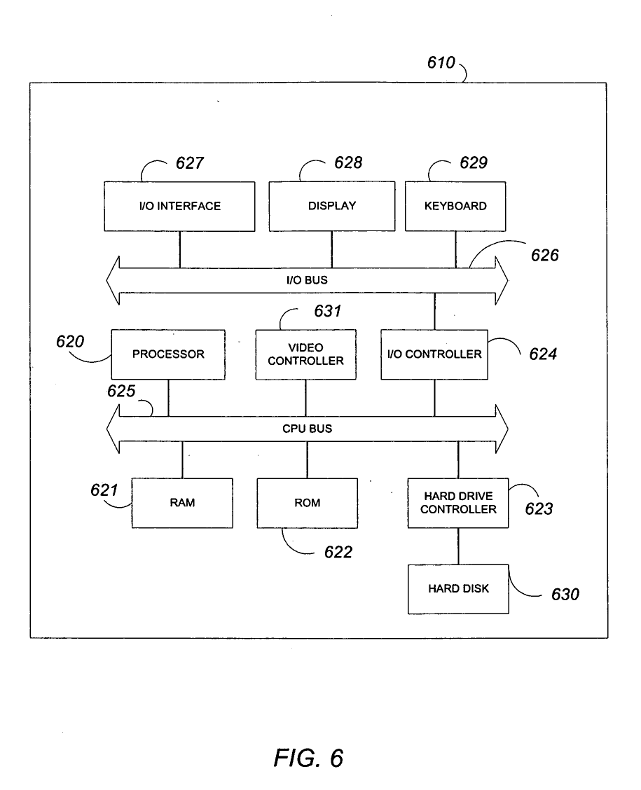

An example of one such type of computer is shown in FIG. 6, which shows a block diagram of a programmable processing system (system) 610 suitable for implementing or performing the apparatus or methods of the invention. The system 610 includes a processor 620, a random access memory (RAM) 621, a program memory 622 (for example, a writable read-only memory (ROM) such as a flash ROM), a hard drive controller 623, a video controller 631, and an input/output (I/O) controller 624 coupled by a processor (CPU) bus 625. The system 610 can be preprogrammed, in ROM, for example, or it can be programmed (and reprogrammed) by loading a program from another source (for example, from a floppy disk, a CD-ROM, or another computer).

The hard drive controller 623 is coupled to a hard disk 630 suitable for storing executable computer programs, including programs embodying the present invention, and data.

The I/O controller 624 is coupled by means of an I/O bus 626 to an I/O interface 627. The I/O interface 627 receives and transmits data (e.g., stills, pictures, movies, and animations for importing into a composition) in analog or digital form over communication links such as a serial link, local area network, wireless link, and parallel link.

Also coupled to the I/O bus 626 is a display 628 and a keyboard 629. Alternatively, separate connections (separate buses) can be used for the I/O interface 627, display 628 and keyboard 629.

The invention has been described in terms of particular embodiments. Other embodiments are within the scope of the following claims. For example, the steps of the invention can be performed in a different order and still achieve desirable results.

1. A system comprising:
(a) multiple virtual patients, each virtual patient comprising:
(i) a model of one or more biological systems and
(ii) a parameter set representing a single individual;
(b) an associating subsystem operable to associate input data about a subject with one or more of the parameter sets to identify the subject with one or more of the virtual patients; and
(c) a simulation engine operable to apply one or more experimental protocols to the one or more virtual patients identified with the subject to generate a set of outputs, wherein the set of outputs projects an outcome for the subject relative to the one or more biological systems represented by the model.

2. The system of claim 1, wherein each of the multiple virtual patients share a common model.

3. The system of claim 1, wherein the associating subsystem is operable to associate the input data with the one or more parameters sets under conditions where said input data and said one or more parameters sets are not completely matched.

4. The system of claim 1, wherein the model is a mechanistic model.

5. The system of claim 1, wherein the set of outputs comprises a prognosis for the subject.

6. The system of claim 1, wherein the set of outputs comprises a diagnosis for the subject.

7. The system of claim 1, wherein experimental protocol represents passage of time.

8. The system of claim 1, wherein the experimental protocol represents a therapeutic regimen.

9. The system of claim 8, wherein the therapeutic regimen is selected from the group consisting of surgical procedures, lifestyle changes and administration of one or more drugs.

10. The system of claim 8, wherein the set of outputs comprises a prediction of therapeutic efficacy for each therapeutic regimen in the subject.

11. The system of claim 1, wherein the input data comprises observations by a medical practitioner.

12. The system of claim 1, wherein the input data comprises historical data about the subject.

13. The system of claim 1, wherein the input data comprises medications currently taken by the subject.

14. The system of claim 1, wherein the input data comprises diagnostic measurements.

15. The system of claim 1, wherein the input data comprises at least one subject preference.

16. The system of claim 1, wherein the associating system comprises:
(i) one or more clusters of virtual patients, wherein each virtual patient in each cluster shares one or more common characteristics that taken together differentiate the virtual patients in the cluster from other virtual patients; and
(ii) a correlator operable to associate a subject with a cluster of virtual patients when the input data correlates to the at least one common characteristic shared by the cluster of sets of physiological parameters.

17. The system of claim 16, wherein a cluster of virtual patients consists of one or more virtual patients.

18. The system of claim 1, wherein the associating system comprises:
(i) one or more clusters of virtual patients, wherein each virtual patient in each cluster shares one or more common characteristics that taken together differentiate the virtual patients in the cluster from other virtual patients;
(ii) a comparing subsystem operable to:
(1) compare the one or more common characteristics to the input data;
(2) identify additional data necessary to identify the subject with one or more virtual patients; and
(3) report the additional data to the user; and
(iii) a correlator operable to associate a subject with a cluster of virtual patients when the input data correlates to the at least one common characteristic shared by the cluster of sets of physiological parameters.

19. The system of claim 18, wherein the comparing subsystem further is operable to report to the user one or more diagnostic tests to obtain results relevant to the additional data necessary to identify the subject with one or more virtual patients.

20. The system of claim 18, wherein a cluster of virtual patients consists of one or more virtual patients.

21. The system of claim 1, wherein the associating subsystem is operable to recommend one or more tests.

22. The system of claim 21, wherein the associating subsystem is operable to receive a result from the one or more recommended tests and to associate the result and the input data with one or more of the parameter sets to identify the subject with one or more of the virtual patients.

23. The system of claim 1, wherein the model comprises a computer model representing a set of biological processes associated with the one or more biological systems, wherein each biological process is represented by a set of mathematical relations, wherein each mathematical relation comprises one or more variables representing a biological attribute or a stimuli that can be applied to the biological system.

24. The system of claim 1, wherein the biological system is selected from the group consisting of cardiovascular systems, metabolism, bone, autoimmunity, oncology, respiratory, infection disease, central nervous system, skin, and toxicology.

25. A computer-executable software code for simulating a biological system comprising:
(a) code to define multiple virtual patients, each virtual patient comprising:
(i) a model of one or more biological systems and
(ii) a parameter set representing a single individual;
(b) code to define an associating system operable to associate input data about a subject with one or more of the virtual patients to identify the subject with one or more associated virtual patients; and
(d) code to define a simulation engine operable to apply one or more experimental protocols to each of the one or more associated virtual patients to generate a set of outputs, wherein the set of outputs projects an outcome for the subject relative to the one or more biological systems.

26. The computer-executable software code of claim 25, wherein each of the multiple virtual patients shares a common model.

27. The computer-executable software code of claim 25, wherein the model is a mechanistic model.

28. The computer-executable software code of claim 25, wherein the set of outputs is selected from the group consisting of a prognosis for the subject, a diagnosis for the subject, a prediction of the therapeutic efficacy of a proposed therapeutic regimen for the subject and.

29. The computer-executable software code of claim 25, wherein the code to define the associating system comprises:
(i) code to define one or more clusters of virtual patients, wherein each virtual patient in each cluster shares one or more common characteristics that taken together differentiate the virtual patients in the cluster from other virtual patients; and
(ii) code to define a correlator operable to associate a subject with a cluster of virtual patients when the input data correlates to the at least one common characteristic shared by the cluster of sets of physiological parameters.

30. The computer-executable software code of claim 25, wherein the code to define the associating system comprises:
(i) code to define one or more clusters of virtual patients, wherein each virtual patient in each cluster shares one or more common characteristics that taken together differentiate the virtual patients in the cluster from other virtual patients;
(ii) code to define a comparing subsystem operable to:
(1) compare the one or more common characteristics to the input data;
(2) identify additional data necessary to identify the subject with one or more virtual patients; and
(3) report the additional data to the user; and
(iii) code to define a correlator operable to associate a subject with a cluster of virtual patients when the input data correlates to the at least one common characteristic shared by the cluster of sets of physiological parameters.

31. A method of predicting a therapeutic efficacy for a subject comprising:
(a) defining multiple virtual patients, wherein each virtual patient comprises
(i) a model of one or more biological systems and
(ii) a parameter set representing a single individual;
(b) receiving user input data about a subject;
(c) associating the input data with one or more of the virtual patients to identify the subject with one or more associated virtual patients;
(e) defining one or more experimental protocols that represent potential therapeutic regimens for the subject; and
(f) applying each of the one or more experimental protocols to the one or more associated virtual patients to generate a set of outputs, wherein the set of outputs projects the therapeutic efficacy of the therapeutic regimen for the subject.

32. The method of claim 31, wherein the therapeutic regimen comprises a lifestyle change, administration of a drug or effecting a surgical procedure.

33. The method of claim 31, wherein the model is a mechanistic model.

34. The method of claim 31, wherein associating the input data with one or more parameter sets comprises:
(i) grouping virtual patients, wherein each virtual patient in a group shares one or more common characteristics that taken together differentiate the virtual patients in the group from other virtual patients;
(ii) comparing the one or more common characteristics to the input data; and
(iii)associating the subject with a group of virtual patients when the input data correlates to the one or more common characteristics shared by the parameter sets in the group.

35. The method of claim 31, wherein associating the input data with one or more parameter sets comprises:
(i) grouping virtual patients, wherein each virtual patient in a group shares one or more common characteristics that taken together differentiate the virtual patients in the group from other virtual patients;
(ii) comparing the one or more common characteristics to the input data;
(iii)identifying additional data necessary to identify the subject with one or more virtual patients and reporting one or more tests to obtain the additional data;
(iv)receiving results from the one or more tests to obtain the additional data; and
(v) associating the subject with a group of virtual patients when the input data and additional data correlate to the one or more common characteristics shared by the virtual patients in the group.

36. The method of claim 35, wherein steps (iii) and (iv) are repeated.

37. The method of claim 35, wherein the group of virtual patients consists of one virtual patient having one or more characteristics that together differentiate the one virtual patient from all other virtual patients.

38. The method of claim 31, further comprising identifying additional data necessary to identify the subject with one or more virtual patients, reporting one or more tests to obtain the additional data, and receiving results from the one or more tests to obtain the additional data, prior to associating the input data, including the additional data, with one or more of the virtual patients to identify the subject with one or more associated virtual patients.

39. The method of claim 31, further comprising modifying a virtual patient to generate a new virtual patient that better represents the subject.

40. The method of claim 31, wherein the model comprises a computer model representing a set of biological processes associated with the one or more biological systems, wherein each biological process is represented by a set of mathematical relations, wherein each mathematical relation comprises one or more variables representing a biological attribute or a stimuli that can be applied to the biological system.

41. The method of claim 31, wherein the user input comprises a subject preference.

42. The method of claim 41, wherein the subject preference is a willingness of the subject to change diet, to undergo surgery, to exercise, and/or to comply with a recommended treatment regimen.

43. The method of claim 31, wherein the user input data comprises real-time measurements of physical characteristics of the subject.

44. The method of claim 31, further comprising:
(g) receiving updated user input over time;
(h) associating the updated input data with one or more of the parameter sets to identify one or more updated associated parameter sets; and
(i) applying each of the one or more updated associated parameter sets to the model, to generate an updated set of outputs, wherein the updated set of outputs projects the therapeutic efficacy of the therapeutic regimen for the subject.

45. The method of claim 31, further comprising:
(g) grouping virtual patients that generate similar outcomes;
(h) identifying one or more common characteristics that taken together differentiate the grouped virtual patients from all other virtual patients; and
(i) reporting the identity of the one or more common characteristics to the user.

46. The method of claim 45, further comprising reporting to the user one or more diagnostic tests to obtain results relevant to the one or more common characteristics.

47. A method of monitoring effectiveness of a therapeutic regimen in a subject comprising:
(a) defining multiple virtual patients, wherein each virtual patient comprises
(i) a model of one or more biological systems and
(ii) a parameter set representing a single individual;
(b) receiving user input data about a subject;
(c) associating the input data with one or more of the virtual patients to identify the subject with one or more associated virtual patients;
(e) defining one or more experimental protocols that represent potential therapeutic regimens for the subject;
(f) applying each of the one or more experimental protocols to the one or more associated virtual patients to generate a set of outputs;
(g) performing a correlation analysis on the set of outputs to identify one or more biomarkers of therapeutic efficacy; and
(h) monitoring the one or more biomarkers of therapeutic efficacy.
